(19) United States
(12) Patent Application Publication
(10) Pub. No.: US 2022/0178805 A1
(43) Pub. Date: Jun. 9, 2022

(54) DETERMINATION OF THE RHEOLOGICAL BEHAVIOR OF A FLUID

(71) Applicant: Bayer Aktiengesellschaft, Leverkusen (DE)

(72) Inventor: Gary SIMMONS, Madison, NJ (US)

(73) Assignee: Bayer Aktiengesellschaft, Leverkusen (DE)

(21) Appl. No.: 17/594,666

(22) PCT Filed: Apr. 23, 2020
(86) PCT No.: PCT/EP2020/061266

§ 371 Date: Oct. 25, 2021

Related U.S. Application Data
(60) Provisional application No. 62/840,099, filed on Apr. 29, 2019.

(51) Int. Cl. G01N 11/02; G06T 7/00; G01N 11/10

(52) U.S. Cl. CPC G01N 11/02; G01N 2011/008; G01N 11/10; G06T 7/0004

(57) ABSTRACT

The present disclosure relates to the determination of the rheological behavior of a fluid.

### CROSS REFERENCE TO RELATED APPLICATIONS

This application is a national stage application under 35 U.S.C. §371 of International Application No. PCT/EP2020/061266, filed internationally on Apr. 23, 2020, which claims benefit of U.S. Provisional Application No.: 62/840,099, filed Apr. 29, 2019.

### FIELD OF INVENTION

The present disclosure relates to the determination of the rheological behavior of a fluid.

### BACKGROUND OF THE INVENTION

The determination of the rheological behavior of a fluid is a measurement technique usually required for quality management, performance evaluation, source material management, research and development in manufacturing processes of medicine, food, paint, ink, cosmetics, chemicals, paper, adhesives, fiber, plastic, detergent, concrete admixtures, silicon, blood and so on.

Foods, cosmetics and pharmaceutical products are commonly formulated to achieve desirable properties. A great deal of effort is spent by laboratory personnel developing these formulas to provide the correct balance of properties.

For many materials, rheological characteristics are key indicators of quality (L. Gilbert et al.: Predicting sensory texture properties of cosmetic emulsions by physical measurements, Chemometrics and Intelligent Laboratory Systems 124 (2013) 21-31).

Newtonian fluids can be characterized by a single coefficient of viscosity for a specific temperature. Although this viscosity changes with temperature, it does not change with the strain rate. Only a small group of fluids exhibit such constant viscosity. For a large quantity of fluids, the viscosity changes with the strain rate (the relative flow velocity); such fluids are called non-Newtonian fluids.

Rheology generally accounts for the behavior of non-Newtonian fluids by characterizing the minimum number of functions that are needed to relate stresses with rate of change of strain or strain rates.

A viscometer can only determine the viscosity values of a sample. This can be done by performing rotational tests, mostly speed-controlled, or by using other methods of testing. The results are presented as flow curves or viscosity curves.

Rheometers are able to determine many more rheological parameters. Modern rheometers can be used for shear tests and torsional tests. They operate with continuous rotation and rotational oscillation. Specific measuring systems can be used to carry out uniaxial tensile tests either in one direction of motion or as oscillatory tests.

There are several physical quantities and parameters which can be obtained by rheological measurements and which can be used to describe a fluid, such as the Deborah number, the Reynolds number, the yield point, the dynamic viscosity, the kinematic viscosity, and many more (see e.g. T. G. Mezger: The Rheology Handbook, 2^{nd} Ed., Vincentz Network 2006, ISBN: 3-87870-174-8).

### SUMMARY OF THE INVENTION

Often, a measured parameter is dependent on the measurement conditions. As a result, parameters describing the measurement conditions are usually specified when the measured parameter is reported.

In many cases, rheological properties are determined offline; however, it is of increasing importance to determine material properties directly in or during the manufacturing process.

According to some embodiments, the present invention provides a novel method and a novel system for determining rheological behavior of fluids. The invention can be used for determining one or more rheological properties of a fluid during the manufacturing process. It operates contact-free. It is flexible and can be adapted to different processes. It can even be used for controlling the manufacturing process.

In some embodiments, the present invention relates to a method for determining at least one rheological property of a fluid, the method comprising:
acquiring a sequence of images of the fluid in motion,
transmitting the sequence of images to a prediction model as an input signal for determining the rheological property, wherein the prediction model is trained by history and/or calibration data to predict the relationship between visible features of the fluid in motion and at least a rheological property of the fluid,
receiving as an output from the prediction model the rheological property.

In some embodiments, the present invention relates to a system comprising:
an image acquisition unit for acquiring a sequence of images of a fluid in motion, and
a computing system comprising:
   a memory; and
   a processing unit in communication with the memory and configured with processor-executable instructions to perform operations comprising:
      receiving a sequence of images captured by the image acquisition unit;
      feeding the sequence of images into a prediction model, wherein the prediction model is trained by history and/or calibration data to predict the relationship between visible features of the fluid in motion and at least a rheological property of the fluid;
      receiving as an output from the prediction model a rheological property; and
      outputting the rheological property.

According to some embodiments, the present invention serves to determine at least one rheological property of a fluid in motion by means of an image acquisition unit and a prediction model.

A fluid is a substance or a mixture of substances that continually deforms (flows) under an applied shear stress or external force.

In some embodiments, a fluid can be e.g. a medicine, food (e.g. chocolate), paint, ink, cosmetic, chemical, paper, adhesive, fiber, plastic, detergent, concrete admixture, silicon, blood or the like.

In some embodiments of the present invention, the fluid may be a pharmaceutical or a cosmetic, in particular a cream, an ointment, a lotion, or a precursor for manufacturing said pharmaceutical or cosmetic.

In some embodiments, a rheological property may be a parameter, physical unit or dimensionless number which can be used to at least partially describe the deformation (flow) of the fluid under an applied shear stress or external force.

In some embodiments, a rheological property can also be a parameter, physical unit or dimensionless number which can be used to describe a property of the fluid which is related to and/or can be deduced from and/or can be derived from the behavior of the fluid under an applied shear stress or external force, such as the sensual texture or the like.

In some embodiments, the at least one rheological property is determined from a sequence of images captured by one or more image acquisition units. Said image acquisition unit can be a camera which is configured to take images of the fluid in motion at predefined times and/or at predefined time intervals. A sequence of images may contain at least two images. Preferably it contains more than ten images; more preferably it contains more than one hundred images.

In some embodiments of the present invention, the image acquisition unit is configured to capture images at a fixed rate of 1 to 100 Hz over a predefined period of 0.1 second to 10 minutes.

Preferably, the images have a resolution of at least 100×100 pixels. The images can be greyscale images or RGB images or images of another color format. The images can be raster graphics or vector graphics.

In some embodiments, it is possible to use more than one image acquisition unit, for example to capture the fluid in motion from different angles and/or to capture light scattered from the fluid in motion having different spectra.

In some embodiments, one or more light sources can be used to illuminate the fluid in motion. If more than one light source is used, the different light sources can illuminate the fluid from different angles. The light source(s) and the image acquisition unit(s) may be arranged so that the light source(s) illuminate(s) the fluid in motion, and the image acquisition unit(s) capture(s) the light scattered from the fluid in motion.

For illuminating the fluid in motion, the light can be monochromatic or polychromatic. The wavelength of the light used for illuminating the fluid can for example be light in the ultraviolet, the visible and/or the infrared range of the electromagnetic spectrum.

In some embodiments, the sequence of images shows the fluid in motion at different time points (snapshots). Each image may comprise information (such as a time stamp) from which the time distance between the image and the preceding image and/or the successive image can be determined.

Fluid in motion means that the fluid moves or is moved by an external force/external forces. The external force can be the gravity force and/or forces applied to the fluid e.g. by an agitator.

In some embodiments, one or more agitators (mixers) are used to agitate the fluid which force(s) the fluid to move.

In some embodiments, the agitation of the fluid is performed in a predefined way: at a predefined temperature, at a predefined rotational speed of the agitator(s), with (a) predefined type(s) of agitator(s), at a predefined pressure, the agitator(s) performing a predefined movement.

In some embodiments , the agitation conditions mentioned above correlate with the measurement conditions prevailed for the generation of history and/or calibration data which are used for training/creating the prediction model. “Correlate” means that the conditions are equal or similar; it means that the fluid behaves in the same way (when the images are captured and when the at least one rheological property is measured by conventional measurement techniques).

In some embodiments, the sequence of images of the fluid in motion may be used as input data (input signal) for the prediction model. The prediction model may be configured to determine from the input data one or more parameters which represent(s) at least one rheological behavior of the fluid. In some embodiments, the prediction model may have been trained with sequences of images of fluids in motion for which the rheological properties have been determined in the past, and with the data representing the determined rheological properties. In some embodiments, a (conventional) rheometer is used to measure one or more parameters representing at least one rheological property of the fluid. The data measured by using the rheometer are used as training data.

In some embodiments, the aim of the training is to create a regression function which relates the motion of the fluid (as captured in the sequence of images) due to (an) external force(s) with the measured parameter(s) representing the at least one rheological property.

In some embodiments, the prediction model can be an artificial neural network. In some embodiments, the present invention serves to determine at least one rheological property of a fluid by means of an artificial neural network which is based on a learning process referred to as backpropagation.

Backpropagation is understood herein as a generic term for a supervised learning process with error feedback. There are a variety of backpropagation algorithms(e g Quickprop, Resilient Propagation (RPROP)). Details of setting up an artificial neural network and training the network can be found e.g. in C. C. Aggarwal: Neural Networks and Deep Learning, Springer 2018, ISBN 978-3-319-94462-3.

In some embodiments, the present invention uses an artificial neural network comprising at least N layers of processing elements: a first layer with input neurons (nodes), an N^{th} layer with at least one output neuron (nodes), and N−2 inner layers, where N is a natural number greater than 2. Preferably N is equal to 3 or greater than 3.

In such a network, the output neuron(s) serve(s) to predict at least one rheological property of the fluid. The input neurons serve to receive input values (the sequence of images or data derived therefrom).

The processing elements are interconnected in a predetermined pattern with predetermined connection weights between said processing elements. In some embodiments, the network may have been previously trained to simulate the at least one rheological property as a function of the captured motion of the fluid.

When trained, the connection weights between the processing elements may contain information regarding the relationship between the captured motion of the fluid (input) and the measured rheological properties (output) of the fluid, which may be used to predict at least one rheological property of a new fluid.

In some embodiments, a network structure can be constructed with input nodes for each input variable, one or more hidden nodes, and at least one output node for the parameter representing the at least one rheological property of the fluid. The nodes may be connected by weight connections between input and hidden, between hidden and hidden (in case N>3), and/or between hidden and output node(s). Additional threshold weights may be applied to the hidden and output nodes. Each network node may represent a simple calculation of the weighted sum of inputs from prior nodes and a non-linear output function. The combined calculation of the network nodes relates the inputs to the output(s).

In some embodiments, separate networks can be developed for each property measurement or groups of properties can be included in a single network.

Training estimates network weights that allow the network to calculate (an) output value(s) close to the measured output value(s). A supervised training method can be used in which the output data is used to direct the training of the network weights. The network weights are initialized with small random values or with the weights of a prior partially trained network. The process data inputs are applied to the network and the output values are calculated for each training sample. The network output values are compared to the measured output values. A backpropagation algorithm is applied to correct the weight values in directions that reduce the error between measured and calculated outputs. The process is iterated until no further reduction in error can be made. A cross-validation method is employed to split the data into training and testing data sets. The training data set is used in the backpropagation training of the network weights. The testing data set is used to verify that the trained network generalizes to make good predictions. The best network weight set can be taken as the one that best predicts the outputs of the test data set. Similarly, varying the number of network hidden nodes and determining the network that performs best with the test data optimizes the number of hidden nodes.

Forward prediction uses the trained network to calculate estimates of property outputs for new fluids. A sequence of images of a fluid in motion is input to the trained network. A feed forward calculation through the network is made to predict the output property value(s). The predicted measurements can be compared to (a) property target value(s) or tolerance(s).

Since the method of the invention is based on historical (calibration) data of property values, the prediction of property values using such method typically have an error approaching the error of the empirical data, so that the invention predictions are often just as accurate as verification experiments.

In some embodiments of the present invention, the prediction model is or comprises a convolutional neural network (CNN).

A CNN is a class of deep neural networks, most commonly applied to analyzing visual imagery. A CNN comprises an input layer with input neurons, an output layer with at least one output neuron, as well as multiple hidden layers between the input layer and the output layer.

The hidden layers of a CNN typically consist of convolutional layers, ReLU (Rectified Linear Units) layers (i.e. activation functions), pooling layers, fully connected layers and normalization layers.

The nodes in the CNN input layer are organized into a set of “filters” (feature detectors), and the output of each set of filters is propagated to nodes in successive layers of the network. The computations for a CNN include applying the convolution mathematical operation to each filter to produce the output of that filter. Convolution is a specialized kind of mathematical operation performed by two functions to produce a third function that is a modified version of one of the two original functions. In convolutional network terminology, the first function to the convolution can be referred to as the input, while the second function can be referred to as the convolution kernel. The output may be referred to as the feature map. For example, the input to a convolution layer can be a multidimensional array of data that defines the various color components of an input image. The convolution kernel can be a multidimensional array of parameters, where the parameters are adapted by the training process for the neural network.

When moving from image to video analysis with CNNs, the complexity of the task is increased by the extension into the temporal dimension. This dimension can be processed by introducing 3D convolutions, additional multi-frame optical flow images, or recurrent neural networks (RNNs).

Recurrent neural networks (RNNs) are a family of feedforward neural networks that include feedback connections between layers. RNNs enable modeling of sequential data by sharing parameter data across different parts of the neural network. The architecture for an RNN includes cycles. The cycles represent the influence of a present value of a variable on its own value at a future time, as at least a portion of the output data from the RNN is used as feedback for processing subsequent input in a sequence.

When analyzing video material (a sequence of images), space and time can be treated as equivalent dimensions and processed via e.g., 3D convolutions. This was explored in the works of Baccouche et al. (Sequential Deep Learning for Human Action Recognition; International Workshop on Human Behavior Understanding, Springer 2011, pages 29-39) and Ji et al. (3D Convolutional Neural Networks for Human Action Recognition, IEEE transactions on pattern analysis and machine intelligence, 35(1), 221-231). On the other hand, one can train different networks, responsible for time and space, and finally fuse the features, which can be found in publications of Karpathy et al. (Large-scale Video Classification with Convolutional Neural Networks; Proceedings of the IEEE conference on Computer Vision and Pattern Recognition, 2014, pages 1725-1732), and Simonyan & Zisserman (Two-stream Convolutional Networks for Action Recognition in Videos; Advances in neural information processing systems, 2014, pages 568-576).

In some embodiments, the prediction model of the present invention is sensitive to local motion. A local motion covers short periods of time (in the range of seconds) and tries to draw an inference from them.

In some embodiments of the present invention, one or more sensors may be used to collect measurement data representative of the conditions during the generation of the sequence of images, such as one or more temperature sensors to measure the temperature of the fluid in motion, one or more pressure sensors to measure the pressure applied to the fluid, and the like.

Since the conditions can exert an influence on the at least one rheological property of the fluid, the collected measurement data can be used as additional input parameters for the prediction unit (during training and prediction).

In some embodiments, the trained prediction model can also be used to control the manufacturing process of a product.

In some embodiments, the present invention relates to a system for controlling a process for producing a product having at least one desired product property, the system comprising:
an image acquisition unit for capturing a sequence of images of the product in a fluid state or of a fluid precursor of the product, the fluid product or fluid precursor being in motion;
a prediction unit arranged to receive at least one sequence of images from the image acquisition unit and to determine at least one property parameter representative of a rheological property of the fluid product or fluid precursor on the basis of the at least one sequence of images;
control means arranged to compare the property parameter with a set point and to determine control output data representative of the mismatch between the property parameter and the set point; and
actuating means arranged to receive said control output data and to change at least one process condition that affects said at least one product property in response to said received control output data.

In some embodiments, the present invention relates to method of controlling a process for producing a product having at least one desired product property, the method comprising the steps:
acquiring a sequence of images of the product in a fluid state or of a fluid precursor of the product, the fluid product or fluid precursor being in motion;
feeding the sequence of images as an input to a prediction model;
receiving from the prediction model at least one property parameter representative of a rheological property of the fluid product or fluid precursor;
comparing the property parameter with a set point;
determining control output data representative of the mismatch between the property parameter and the set point; and
change at least one process condition that affects said at least one product property in response to said received control output data.

Also provided is a computer program comprising computer program code means for performing any of the methods shown and described herein when the program is run on at least one computer, and a computer program product, comprising a non-transitory computer-usable or -readable storage medium, typically tangible, having a computer readable program code embodied therein, the computer readable program code adapted to be executed to implement any or all of the methods shown and described herein.

The operations in accordance with the teachings herein may be performed by at least one computer specially constructed for the desired purposes or a general-purpose computer specially configured for the desired purpose by at least one computer program stored in a non-transitory computer readable storage medium. The term “non-transitory” is used herein to exclude transitory, propagating signals or waves, but to otherwise include any volatile or non-volatile computer memory technology suitable to the application.

Any suitable processor/s, display and input means may be used to process, display e.g. on a computer screen or other computer output device, store, and accept information such as information used by or generated by any of the methods and apparatus shown and described herein; the above processor/s, display and input means including computer programs, in accordance with some or all of the embodiments of the present invention. Any or all functionalities of the invention shown and described herein, such as but not limited to operations within flowcharts, may be performed by any one or more of: at least one conventional personal computer processor, workstation or other programmable device or computer or electronic computing device or processor, either general-purpose or specifically constructed, used for processing; a computer display screen and/or printer and/or speaker for displaying; machine-readable memory such as optical disks, CDROMs, DVDs, BluRays, magnetic-optical discs or other discs; RAMs, ROMs, EPROMs, EEPROMs, magnetic or optical or other cards, for storing, and keyboard or mouse for accepting. Modules shown and described herein may include any one or combination or plurality of: a server, a data processor, a memory/computer storage, a communication interface, a computer program stored in memory/computer storage.

The term “process” as used above is intended to include any type of computation or manipulation or transformation of data represented as physical, e.g. electronic, phenomena which may occur or reside e.g. within registers and/or memories of at least one computer or processor. The term processor includes a single processing unit or a plurality of distributed or remote such units.

The above devices may communicate via any conventional wired or wireless digital communication means, e.g. via a wired or cellular telephone network or a computer network such as the Internet.

The system of the present invention may include, according to some embodiments of the invention, machine readable memory containing or otherwise storing a program of instructions which, when executed by the machine, implements some or all of the system, methods, features and functionalities of the invention shown and described herein. In some embodiments, the system of the present invention may include a program as above which may be written in any conventional programming language, and optionally a machine for executing the program such as but not limited to a general-purpose computer which may optionally be configured or activated in accordance with the teachings of the present invention. Any of the teachings incorporated herein may, wherever suitable, operate on signals representative of physical objects or substances.

The term “computer” should be broadly construed to cover any kind of electronic device with data processing capabilities, including, by way of non-limiting example, personal computers, servers, embedded cores, computing system, communication devices, processors (e.g. digital signal processor (DSP), microcontrollers, field programmable gate array (FPGA), application specific integrated circuit (ASIC), etc.) and other electronic computing devices.

Any suitable input device, such as but not limited to a sensor, may be used to generate or otherwise provide information received by the system and methods shown and described herein. Any suitable output device or display may be used to display or output information generated by the system and methods shown and described herein. Any suitable processor/s may be employed to compute or generate information as described herein and/or to perform functionalities described herein and/or to implement any engine, interface or other system described herein. Any suitable computerized data storage e.g. computer memory may be used to store information received by or generated by the systems shown and described herein. Functionalities shown and described herein may be divided between a server computer and a plurality of client computers. These or any other computerized components shown and described herein may communicate between themselves via a suitable computer network.

Some implementations of the present disclosure will now be described more fully hereinafter with reference to the accompanying drawings, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art. As used herein, for example, the singular forms “a”, “an”, “the” and the like include plural referents unless the context clearly dictates otherwise. The terms “data”, “information”, “content” and similar terms may be used interchangeably, according to some example implementations of the present invention, to refer to data capable of being transmitted, received, operated on, and/or stored. Also, for example, reference may be made herein to quantitative measures, values, relationships or the like. Unless otherwise stated, any one or more if not all of these may be absolute or approximate to account for acceptable variations that may occur, such as those due to engineering tolerances or the like. Like reference numerals refer to like elements throughout.

### BRIEF DESCRIPTION OF THE DRAWINGS

The disclosure will now be described, by way of example only, with reference to the accompanying drawings, in which:

FIG. 1 shows a system for determining rheological behavior of a fluid, according to some embodiments;

FIG. 2 illustrates a detailed computing system for determining rheological behavior of a fluid, according to some embodiments;

FIG. 3 shows a system for determining rheological behavior of a fluid according to the some embodiments;

FIG. 4 shows a vessel which is equipped with a window, according to some embodiments;

FIG. 5 shows a system for determining rheological behavior of a fluid, according to some embodiments;

FIG. 6 shows a system for determining rheological behavior of a fluid, according to some embodiments;

FIG. 7 shows a system for determining rheological behavior of a fluid, according to some embodiments;

FIG. 8 shows a system for determining rheological behavior of a fluid, according to some embodiments;

FIG. 9 shows a system for determining rheological behavior of a fluid, according to some embodiments;

FIG. 10 shows a flow chart of a method of determining rheological behavior of a fluid, according to some embodiments;

FIG. 11 shows a flow chart of a method of determining rheological behavior of a fluid, according to some embodiments;

FIG. 12 shows a flow chart of a method of determining rheological behavior of a fluid, according to some embodiments;

FIG. 13 illustrates various layers within a convolutional neural network (CNN), according to some embodiments;

FIG. 14 illustrates computation stages within a convolutional layer of a CNN, according to some embodiments;

FIG. 15 illustrates a recurrent neural network according to some embodiments; and

FIG. 16 illustrates training and deployment of a neural network, according to some embodiments.

### DETAILED DESCRIPTION

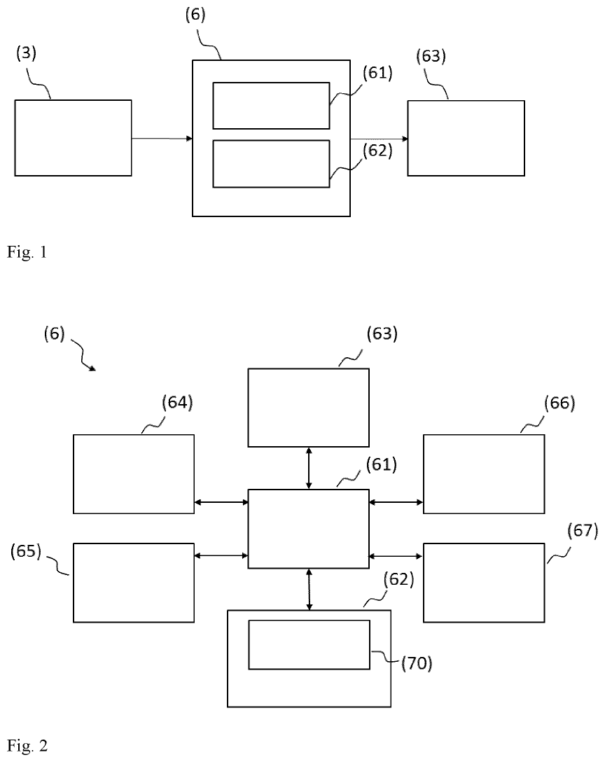

FIG. 1 shows a system for determining rheological behavior of a fluid, according to some embodiments. The system comprises an image acquisition unit (3) and a computing system (6). The computing system comprises a processing unit (61), a memory (62), and an output unit (63) for outputting of information.

The image acquisition unit (3) can be used for capturing a sequence of images of a fluid in motion. The processing unit (61) is configured with processor-executable instructions (stored in the memory (62))
to receive the sequence of images captured by the image acquisition unit,
to determine at least one rheological property of the fluid by feeding the sequence of images into a prediction model, wherein the prediction model is trained by history and/or calibration data to predict the relationship between visible features of the fluid in motion and at least a rheological property of the fluid, and
to cause the output unit to output the rheological property.

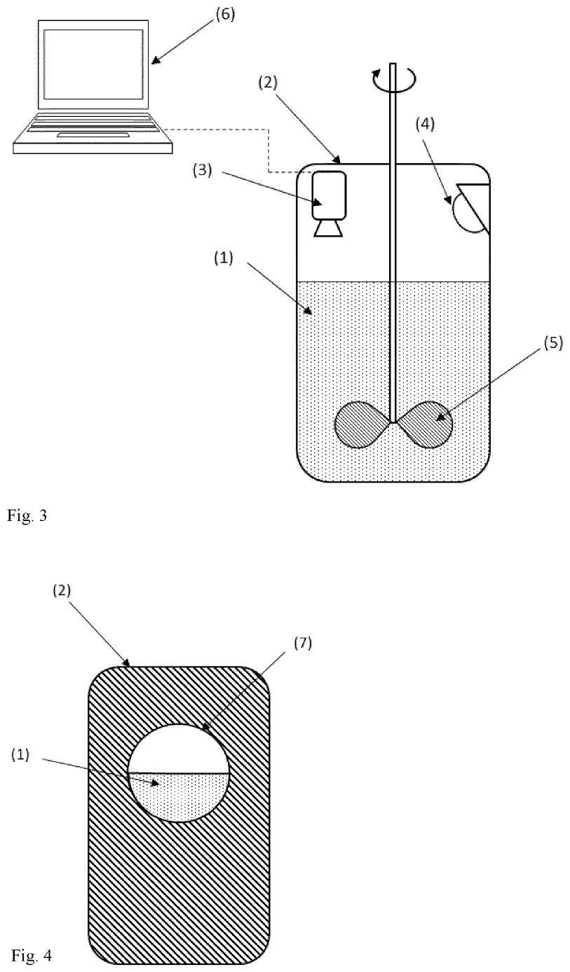

FIG. 2 illustrates a computing system (6) according to some embodiments of the present disclosure in more detail. Generally, a computing system of exemplary implementations of the present disclosure may be referred to as a computer and may comprise, include, or be embodied in one or more fixed or portable electronic devices. The computer may include one or more of each of a number of components such as, for example, processing unit (61) connected to a memory (62) (e.g., storage device).

The processing unit (61) may be composed of one or more processors alone or in combination with one or more memories. The processing unit is generally any piece of computer hardware that is capable of processing information such as, for example, data, computer programs and/or other suitable electronic information. The processing unit is composed of a collection of electronic circuits some of which may be packaged as an integrated circuit or multiple interconnected integrated circuits (an integrated circuit at times more commonly referred to as a “chip”). The processing unit may be configured to execute computer programs, which may be stored onboard the processing unit or otherwise stored in the memory (62) (of the same or another computer).

The processing unit (61) may be a number of processors, a multi-core processor or some other type of processor, depending on the particular implementation. Further, the processing unit may be implemented using a number of heterogeneous processor systems in which a main processor is present with one or more secondary processors on a single chip. In some embodiments, the processing unit may be a symmetric multi-processor system containing multiple processors of the same type. In some embodiments, the processing unit may be embodied as or otherwise include one or more ASICs, FPGAs or the like. Thus, although the processing unit may be capable of executing a computer program to perform one or more functions, the processing unit of various embodiments may be capable of performing one or more functions without the aid of a computer program. In some embodiments, the processing unit may be appropriately programmed to perform functions or operations according to example implementations of the present disclosure.

The memory (62) is generally any piece of computer hardware that is capable of storing information such as, for example, data, computer programs (e.g., computer-readable program code (70)) and/or other suitable information either on a temporary basis and/or a permanent basis. The memory may include volatile and/or non-volatile memory, and may be fixed or removable. Examples of suitable memory include random access memory (RAM), read-only memory (ROM), a hard drive, a flash memory, a thumb drive, a removable computer diskette, an optical disk, a magnetic tape or some combination of the above. Optical disks may include compact disk-read only memory (CD-ROM), compact disk-read/write (CD-R/W), DVD or the like. In various instances, the memory may be referred to as a computer-readable storage medium. The computer-readable storage medium is a non-transitory device capable of storing information, and is distinguishable from computer-readable transmission media such as electronic transitory signals capable of carrying information from one location to another. Computer-readable medium as described herein may generally refer to a computer-readable storage medium or computer-readable transmission medium.

In addition to the memory (62), the processing unit (61) may also be connected to one or more interfaces for displaying, transmitting and/or receiving information. The interfaces may include one or more communications interfaces and/or one or more user interfaces. The communications interface(s) may be configured to transmit and/or receive information, such as to and/or from other computer(s), network(s), database(s) or the like. The communications interface may be configured to transmit and/or receive information by physical (wired) and/or wireless communications links. The communications interface(s) may include interface(s) (66) to connect to a network, such as using technologies such as cellular telephone, Wi-Fi, satellite, cable, digital subscriber line (DSL), fiber optics and the like. In some examples, the communications interface(s) may include one or more short-range communications interfaces (67) configured to connect devices using short-range communications technologies such as NFC, RFID, Bluetooth, Bluetooth LE, ZigBee, infrared (e.g., IrDA) or the like.

The user interfaces may include an output unit (63) such as a display. The display may be configured to present or otherwise display information to a user, suitable examples of which include a liquid crystal display (LCD), light-emitting diode display (LED), plasma display panel (PDP) or the like. The user input interface(s) (64) may be wired or wireless, and may be configured to receive information from a user into the computing system (6), such as for processing, storage and/or display. Suitable examples of user input interfaces include a microphone, image or video capture device (image acquisition unit), keyboard or keypad, joystick, touch-sensitive surface (separate from or integrated into a touchscreen) or the like. In some embodiments, the user interfaces may include automatic identification and data capture (AIDC) technology (65) for machine-readable information. This may include barcode, radio frequency identification (RFID), magnetic stripes, optical character recognition (OCR), integrated circuit card (ICC), and the like. The user interfaces may further include one or more interfaces for communicating with peripherals such as printers and the like.

As indicated above, program code instructions may be stored in memory, and executed by processing unit that is thereby programmed, to implement functions of the systems, subsystems, tools and their respective elements described herein. As will be appreciated, any suitable program code instructions may be loaded onto a computer or other programmable apparatus from a computer-readable storage medium to produce a particular machine, such that the particular machine becomes a means for implementing the functions specified herein. These program code instructions may also be stored in a computer-readable storage medium that can direct a computer, processing unit or other programmable apparatus to function in a particular manner to thereby generate a particular machine or particular article of manufacture. The instructions stored in the computer-readable storage medium may produce an article of manufacture, where the article of manufacture becomes a means for implementing functions described herein. The program code instructions may be retrieved from a computer-readable storage medium and loaded into a computer, processing unit or other programmable apparatus to configure the computer, processing unit or other programmable apparatus to execute operations to be performed on or by the computer, processing unit or other programmable apparatus.

Retrieval, loading and execution of the program code instructions may be performed sequentially such that one instruction is retrieved, loaded and executed at a time. In some embodiments , retrieval, loading and/or execution may be performed in parallel such that multiple instructions are retrieved, loaded, and/or executed together. Execution of the program code instructions may produce a computer-implemented process such that the instructions executed by the computer, processing circuitry or other programmable apparatus provide operations for implementing functions described herein.

Execution of instructions by processing unit, or storage of instructions in a computer-readable storage medium, supports combinations of operations for performing the specified functions. In this manner, a computing system (6) may include processing unit (61) and a computer-readable storage medium or memory (62) coupled to the processing circuitry, where the processing circuitry is configured to execute computer-readable program code (70) stored in the memory. It will also be understood that one or more functions, and combinations of functions, may be implemented by special purpose hardware-based computer systems and/or processing circuitry which perform the specified functions, or combinations of special purpose hardware and program code instructions.

FIG. 3 shows a system for determining rheological behavior of a fluid, according to the some embodiments. An image acquisitions unit (3) captures images of a fluid (1) in motion. The fluid (1) is moved by an agitator (5) in a vessel (2). A light source (4) illuminates the fluid (1) in motion.

The image acquisitions unit (3) may be connected to a computing system (6) so that the image acquisitions unit (3) is able to transmit one or more sequences of captured images to the computing system (6).

FIG. 4 shows a vessel (2) which is equipped with a window (7), according to some embodiments. The fluid (1) can be observed through the window (7). An image acquisition unit can be located outside the vessel (2) and can be configured to capture a sequence of images of the fluid (1) in motion through the window (7). The fluid can be illuminated by one or more light sources installed inside and/or outside the vessel (2).

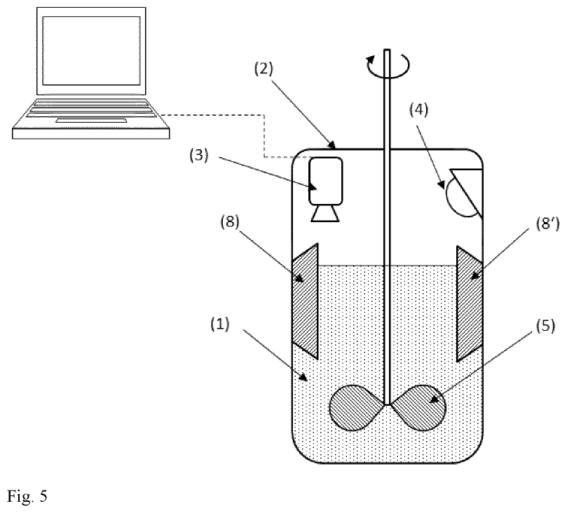

FIG. 5 shows a system for determining rheological behavior of a fluid, according to the some embodiments. An image acquisitions unit (3) captures images of a fluid (1) in motion. The fluid (1) is moved by an agitator (5) in a vessel (2). A light source (4) illuminates the fluid (1) in motion. The vessel (1) is equipped with baffles (8, 8′) which are located inside the vessel (2). The image acquisitions unit (3) is adjusted in a way that it captures the characteristic motion of the fluid (1) at a baffle (8).

The image acquisitions unit (3) may be connected to a computing system (6) so that the image acquisitions unit (3) is able to transmit one or more sequences of captured images to the computing system (6).

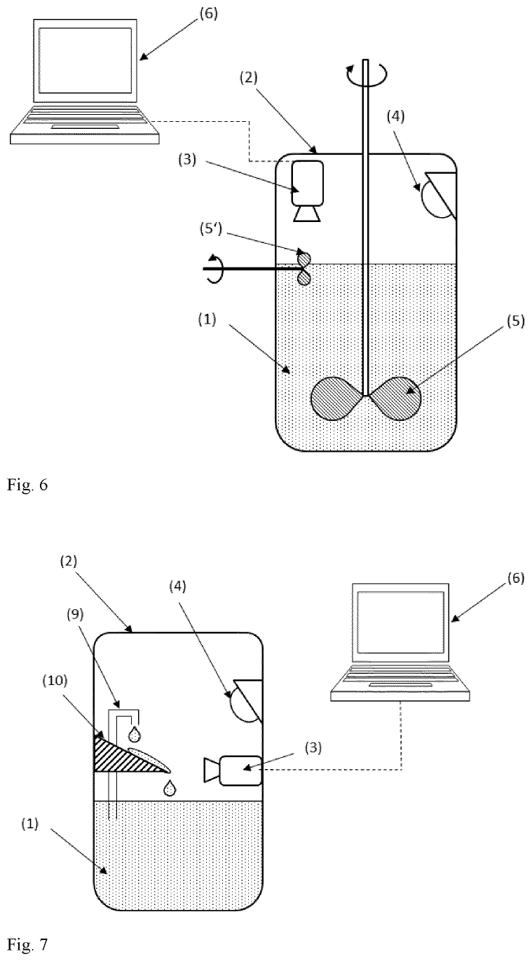

FIG. 6 shows a system for determining rheological behavior of a fluid, according to the some embodiments. An image acquisitions unit (3) captures images of a fluid (1) in a vessel (2). A light source (4) illuminates the fluid (1). The fluid (1) is moved by a first agitator (5) and a second agitator (5′). The image acquisitions unit (3) is adjusted in a way that it captures the characteristic motion of the fluid (1) at the second agitator (5′).

The image acquisitions unit (3) may be connected to a computing system (6) so that the image acquisitions unit (3) is able to transmit one or more sequences of images to the computing system (6).

FIG. 7 shows a system for determining rheological behavior of a fluid, according to the some embodiments. An image acquisitions unit (3) captures images of a fluid (1) in a vessel (2). A light source (4) illuminates the fluid (1). The fluid (1) is conveyed through a conduit (9) onto an inclined plane (10). The fluid flows down the inclined plane. The image acquisitions unit (3) is adjusted in a way that it captures the characteristic motion of the fluid (1) down the inclined plane.

The image acquisitions unit (3) may be connected to a computing system (6) so that the image acquisitions unit (3) is able to transmit one or more sequences of images to the computing system (6).

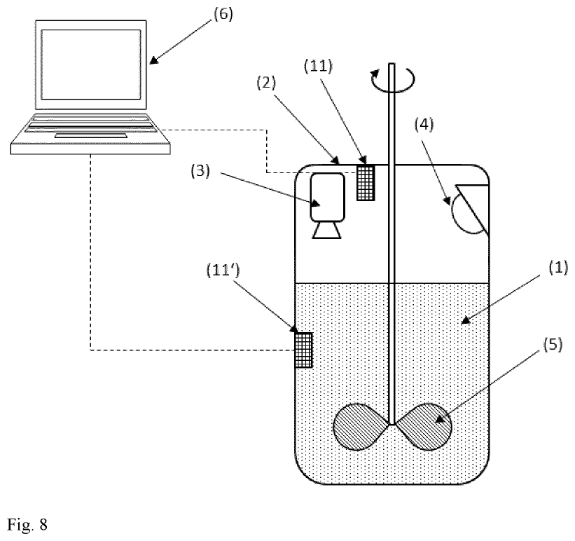

FIG. 8 shows a system for determining rheological behavior of a fluid, according to the some embodiments. An image acquisitions unit (3) captures images of a fluid (1) in motion. The fluid (1) is moved by an agitator (5) in a vessel (2). A light source (4) illuminates the fluid (1) in motion.

The image acquisitions unit (3) may be connected to a computing system (6) so that the image acquisitions unit (3) is able to transmit one or more sequences of images to the computing system (6).

The vessel (2) may be equipped with two more sensors (11, 11′), one sensor (11) being located above the fluid (1), the other sensor (11′) being located within the fluid (1).

The sensors may be used to collect measurement data representative of the conditions during the generation of the sequence of images, such as the temperature of the fluid in motion, and the pressure applied to the fluid.

The sensors may be connected to the computing system (6) so that the sensors are able to transmit measurement data to the computing system (6).

The measurement data may be used to train the prediction model and/or to determine one or more rheological properties by using the trained prediction model.

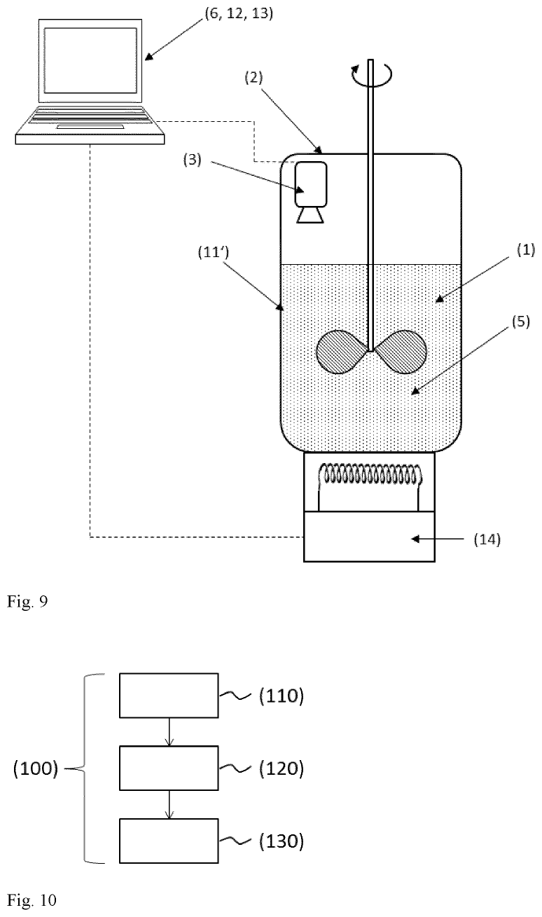

FIG. 9 shows a system for determining rheological behavior of a fluid, according to the some embodiments. The system is configured to control a process for producing a product having at least one desired product property. The system comprises an image acquisition unit (3), a computing unit (6), and actuating means (14).

The image acquisition unit (3) may be used for capturing one or more sequences of images of the product in a fluid state or of a fluid precursor of the product, the fluid product or fluid precursor (1) being agitated by an agitator (5) in a vessel (2).

In some embodiments, the computing system (6) may serve (at least) two different purposes. In some embodiments, it may act as a prediction unit (12) which may be arranged to receive at least one sequence of images from the image acquisition unit (3) and to determine at least one property parameter representative of a rheological property of the fluid product or fluid precursor (1) on the basis of the at least one sequence of images. In some embodiments, the computing system (6) may act as control means (13) which may be arranged to compare the property parameter with a set point and to determine control output data representative of the mismatch between the property parameter and the set point.

The actuating means (14) may be arranged to receive said control output data and to change at least one process condition that affects said at least one product property in response to said received control output data (e.g. the temperature).

FIG. 10 shows a flow chart of a method (100) of determining rheological behavior of a fluid, according to some embodiments . The method (100) may comprise the following steps:
(110) acquiring a sequence of images of a fluid in motion,
(120) transmitting the sequence of images to a prediction model as an input signal for determining a rheological property, wherein the prediction model is trained by history and/or calibration data to predict the relationship between visible features of the fluid in motion and at least a rheological property of the fluid,
(130) receiving as an output from the prediction model the rheological property.

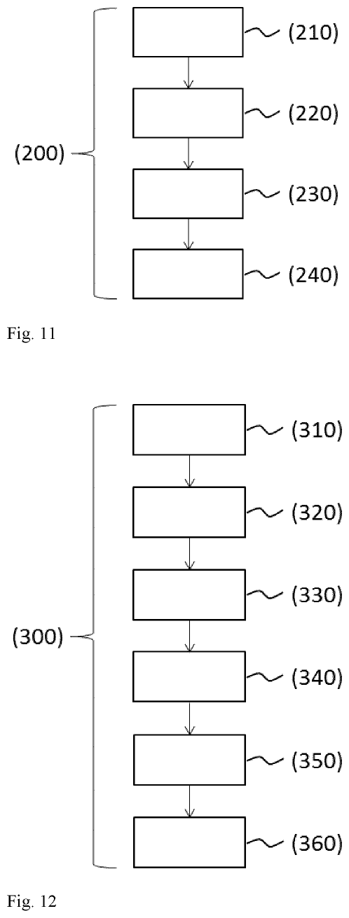

FIG. 11 shows a flow chart of a method (200) of determining rheological behavior of a fluid, according to some embodiments. The method (200) may comprise the following steps:
(210) receiving a sequence of images of a fluid in motion captured by an image acquisition unit,
(220) feeding the sequence of images into a prediction model, wherein the prediction model is trained by history and/or calibration data to predict the relationship between visible features of the fluid in motion and at least a rheological property of the fluid,
(230) receiving as an output from the prediction model a rheological property,
(240) outputting the rheological property.

FIG. 12 shows a flow chart of a method (300) of determining rheological behavior of a fluid, according to some embodiments. The method (300) may comprise the following steps:
(310) acquiring a sequence of images of a product in a fluid state or of a fluid precursor of the product, the fluid product or fluid precursor being in motion;
(320) feeding the sequence of images as an input to a prediction model;
(330) receiving from the prediction model at least one property parameter representative of a rheological property of the fluid product or fluid precursor;
(340) comparing the property parameter with a set point;
(350) determining control output data representative of the mismatch between the property parameter and the set point; and
(360) change at least one process condition that affects said at least one product property in response to said received control output data.

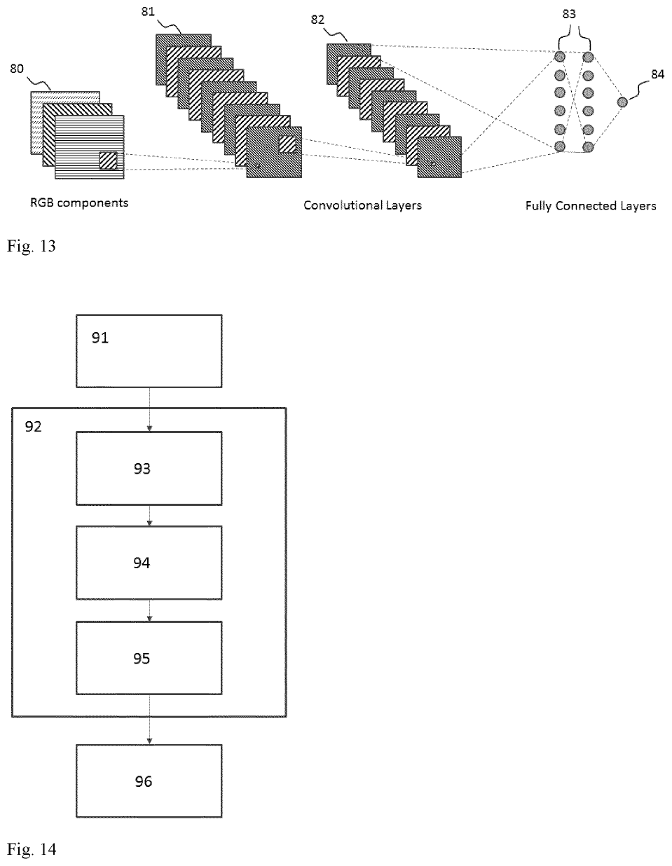

FIGS. 13 and 14 illustrate a convolutional neural network, according to some embodiments. FIG. 13 illustrates various layers within a CNN. As shown in FIG. 13, an exemplary CNN can receive input (80) describing the red, green, and blue (RGB) components of an image. The input (80) can be processed by multiple convolutional layers (e.g., convolutional layer (81), convolutional layer (82)). The output from the multiple convolutional layers may optionally be processed by a set of fully connected layers (83, 84). Neurons in a fully connected layer have full connections to all activations in the previous layer. The output from the fully connected layers (83) can be used to generate an output result (84) from the network.

In some embodiments, the activations within the fully connected layers (83) can be computed using matrix multiplication instead of convolution.

In some embodiments, the convolutional layers are sparsely connected, which differs from traditional neural network configuration found in the fully connected layers (83). Traditional neural network layers are fully connected, such that every output unit interacts with every input unit. When the convolutional layers are sparsely connected, the output of the convolution of a field (instead of the respective state value of each of the nodes in the field) is input to the nodes of the subsequent layer, as illustrated. The kernels associated with the convolutional layers perform convolution operations, the output of which is sent to the next layer. The dimensionality reduction performed within the convolutional layers is one aspect that enables the CNN to process large images.

FIG. 14 illustrates exemplary computation stages within a convolutional layer of a CNN, according to some embodiments. Input (91) to a convolutional layer (92) of a CNN can be processed in three stages of the convolutional layer (92). The three stages can include a convolution stage (93), a detector stage (94), and a pooling stage (95). The convolution layer (92) can then output data to a successive convolutional layer. The final convolutional layer of the network can generate output feature map data or provide input to a fully connected layer, for example, to generate a classification or regression value.

According to some embodiments, in the convolution stage (93), the convolutional layer (92) can perform several convolutions in parallel to produce a set of linear activations. The convolution stage (92) can include an affine transformation, which is any transformation that can be expressed as a sum of a linear transformation and a translation. In some embodiments, affine transformations may include rotations, translations, scaling, and/or combinations of these transformations. In some embodiments, the convolution stage computes the output of functions (e.g., neurons) that are connected to specific regions in the input, which can be determined as the local region associated with the neuron. In some embodiments, the neurons compute a dot product between the weights of the neurons and the region in the local input to which the neurons are connected. The output from the convolution stage (93) may define a set of linear activations that are processed by successive stages of the convolutional layer (92).

In some embodiments, the linear activations can be processed by a detector stage (94). In the detector stage (94), each linear activation may be processed by a non-linear activation function. The non-linear activation function increases the non-linear properties of the overall network without affecting the receptive fields of the convolution layer. Several types of non-linear activation functions may be used. In some embodiments, the non-linear activation function may be the rectified linear unit (ReLU), which uses an activation function defined as f(x)=max(0, x), such that the activation is threshold at zero.

In some embodiments, the pooling stage (95) uses a pooling function that replaces the output of the convolutional layer with a summary statistic of the nearby outputs. The pooling function can be used to introduce translation invariance into the neural network, such that small translations to the input do not change the pooled outputs. Invariance to local translation can be useful in scenarios where the presence of a feature in the input data is more important than the precise location of the feature. Various types of pooling functions can be used during the pooling stage (95), including max pooling, average pooling, and 12-norm pooling. In some embodiments, a CNN implementation may not include a pooling stage. In some embodiments, a pooling stage may be substituted for an additional convolution stage having an increased stride relative to previous convolution stages.

In some embodiments, the output from the convolutional layer (92) can then be processed by the next layer (96). The next layer (96) can be an additional convolutional layer or one of the fully connected layers (83). In some embodiments, the first convolutional layer (81) of FIG. 13 can output to the second convolutional layer (82), while the second convolutional layer can output to a first layer of the fully connected layers (83).

FIG. 15 illustrates a recurrent neural network, according to some embodiments. In a recurrent neural network (RNN), the previous state of the network influences the output of the current state of the network. RNNs can be built in a variety of ways using a variety of functions. The use of RNNs generally revolves around using mathematical models to predict the future based on a prior sequence of inputs. The illustrated RNN can be described has having an input layer (101) that receives an input vector, hidden layers (102) to implement a recurrent function, a feedback mechanism (103) to enable a ‘memory’ of previous states, and an output layer (104) to output a result. The RNN operates based on time-steps.

The state of the RNN at a given time step is influenced based on the previous time step via the feedback mechanism (103). For a given time step, the state of the hidden layers (102) is defined by the previous state and the input at the current time step. An initial input (x₁) at a first time step can be processed by the hidden layer (102). A second input (x₂) can be processed by the hidden layer (102) using state information that is determined during the processing of the initial input (x₁). In some embodiments, a given state can be computed as Sₜ=f(Uxₜ+Wsₜ₋₁), where U and W are parameter matrices. The function f is generally a nonlinear function such as the hyperbolic tangent function (tanh) or a variant of the rectifier function f(x)=max(0, x). However, the specific mathematical function used in the hidden layers (102) can vary depending on the specific implementation details of the RNN.

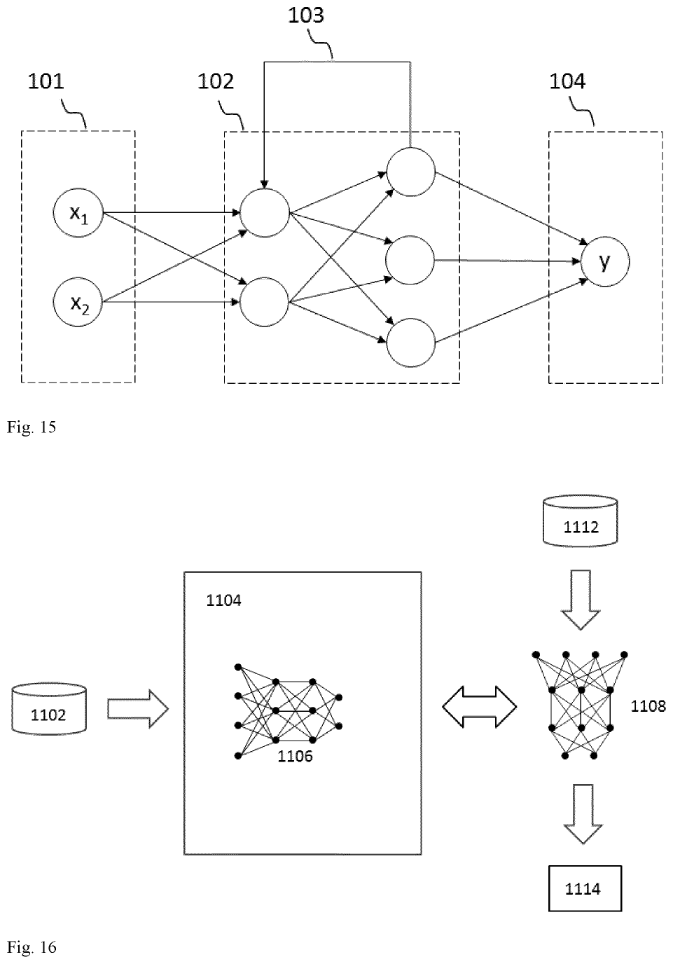

FIG. 16 illustrates training and deployment of a neural network, according to some embodiments. Once a given network has been structured for a task the neural network is trained using a training dataset (1102).

In some embodiments, the initial weights may be chosen randomly or by pre-training using a deep belief network to start the training process. The training cycle then be performed in either a supervised or unsupervised manner Supervised learning is a learning method in which training is performed as a mediated operation, such as when the training dataset (1102) includes input paired with the desired output for the input, or where the training dataset includes input having known output and the output of the neural network is manually graded. The network processes the inputs and compares the resulting outputs against a set of expected or desired outputs. Errors are then propagated back through the system. The training framework (1104) can adjust the weights that control the untrained neural network (1106). The training framework (1104) can provide tools to monitor how well the untrained neural network (1106) is converging towards a model suitable to generating correct answers based on known input data. The training process occurs repeatedly as the weights of the network are adjusted to refine the output generated by the neural network. The training process can continue until the neural network reaches a statistically desired accuracy associated with a trained neural network (1108). The trained neural network (1108) can then be deployed to implement any number of machine learning operations. A sequence of images of a new fluid (1112) can be inputted into the trained neural network (1108) to determine at least one rheological property.

1. A method for determining at least one rheological property of a fluid, the method comprising:
acquiring a sequence of images of the fluid in motion,
transmitting the sequence of images to a prediction model as an input signal for determining the rheological property, wherein the prediction model is trained by history and/or calibration data to predict a relationship between visible features of the fluid in motion and at least a rheological property of the fluid, and
receiving as an output from the prediction model the rheological property.

2. A system comprising:
an image acquisition unit for acquiring a sequence of images of a fluid in motion, and
a computing system comprising:
a memory; and
a processing unit in communication with the memory and configured with processor-executable instructions to:
receiver a sequence of images captured by the image acquisition unit,
feed the sequence of images into a prediction model, wherein the prediction model is trained by history and/or calibration data to predict a relationship between visible features of the fluid in motion and at least a rheological property of the fluid,
receive as an output from the prediction model a rheological property, and
output the rheological property.

3. A system for controlling a process for producing a product having at least one desired product property, the system comprising:
an image acquisition unit for capturing a sequence of images of the product in a fluid state or of a fluid precursor of the product, fluid product or fluid precursor being in motion;
a prediction unit arranged to receive at least one sequence of images from the image acquisition unit and to determine at least one property parameter representative of a rheological property of the fluid product or fluid precursor based on the at least one sequence of images;
control unit arranged to compare the property parameter with a set point and to determine control output data representative of mismatch between the property parameter and the set point; and
actuating unit arranged to receive said control output data and to change at least one process condition that affects said at least one product property in response to said received control output data.

4. A method of controlling a process for producing a product having at least one desired product property, the method comprising the steps:
acquiring a sequence of images of the product in a fluid state or of a fluid precursor of the product, fluid product or fluid precursor being in motion;
feeding the sequence of images as an input to a prediction model;
receiving from the prediction model at least one property parameter representative of a rheological property of the fluid product or fluid precursor;
comparing the property parameter with a set point;
determining control output data representative of mismatch between the property parameter and the set point; and
changing at least one process condition that affects said at least one product property in response to said received control output data.

5. A non-transitory computer readable medium storing one or more programs, the one or more programs configured to determine at least one rheological property of a fluid, the one or more programs comprising instructions, that when executed by a processor, cause the processor to:
acquire a sequence of images of the fluid in motion,
transmit the sequence of images to a prediction model as an input signal for determining the rheological property, wherein the prediction model is trained by history and/or calibration data to predict a relationship between visible features of the fluid in motion and at least a rheological property of the fluid, and
receive as an output from the prediction model the rheological property.

6. A non-transitory computer readable medium storing one or more programs, the one or more programs configured to control a process for producing a product having at least one desired product property, the one or more programs comprising instructions, that when executed by a processor, cause the processor to:
acquire a sequence of images of the product in a fluid state or of a fluid precursor of the product, fluid product or fluid precursor being in motion;
feed the sequence of images as an input to a prediction model;
receive from the prediction model at least one property parameter representative of a rheological property of the fluid product or fluid precursor;
compare the property parameter with a set point;
determine control output data representative of mismatch between the property parameter and the set point; and
change at least one process condition that affects said at least one product property in response to said received control output data.
